(19) United States
(12) Patent Application Publication
(10) Pub. No.: US 2014/0231100 A1
(43) Pub. Date: Aug. 21, 2014

(54) OPTIONALLY GLUED-ON OR NAILED-ON HORSE SHOE

(71) Applicant: GARRETT N. FORD, DURANGO, CO (US)

(72) Inventor: GARRETT N. FORD, DURANGO, CO (US)

(73) Assignee: EASYCARE, INC., TUCSON, AZ (US)

(21) Appl. No.: 14/165,646

(22) Filed: Jan. 28, 2014

Related U.S. Application Data
(60) Provisional application No. 61/766,906, filed on Feb. 20, 2013.
(60) Provisional application No. 61/873,368, filed on Sep. 4, 2013.

(51) Int. Cl. A01L 1/02

(52) U.S. Cl. CPC A01L 1/02
USPC 168/12; 168/4

(57) ABSTRACT

A horse shoe has an upper with independent side walls that conform to the shape of the hoof. The upper includes a toe clip, two side tabs in the front half and two side walls in the rear half of the shoe, preferably all integral with a polymeric horseshoe with heel portions defining a gap. A cantilevered resilient bridge connects the heel portions, thus providing a spring-like structure tying the heel portions together. The top surface of the horseshoe has a grid of interconnected recesses and the upper has lateral perforations adapted to receive glue material. The shoe is fitted to the hoof by lining the surfaces of the upper and the horseshoe with glue and holding the shoe in place while the glue hardens, thereby securing the shoe to the hoof. Alternatively, the shoe is nailed on the hoof like a conventional horseshoe after removing the side walls.

### RELATED APPLICATIONS

This application is based on and claims the priority of Provisional Application Ser. No. 61/766,906, filed Feb. 20, 2013, and of Provisional Application Ser. No. 61/873,368, filed Sep. 4, 2013.

### BACKGROUND OF THE INVENTION

1. Field of the Invention

The invention relates in general to horse shoes, boots and pads used as alternatives to traditional metal horseshoes. In particular, the invention is a horse shoe made of a resilient synthetic material and configured for alternative gluing or nailing on the hoof of the horse.

2. Description of the Prior Art

Horse boots are used to protect the hooves and fetlocks of horses and it has become common place to use them in lieu of conventional horseshoes in a continuing trend toward natural horsemanship. Because of their stiffness, metal horseshoes constrain the hoof and prevent the cyclical contraction and expansion of the frog that enhances blood circulation in the legs when the horse is in its natural state. This pumping effect of the hoof, which has led to the descriptive notion that horses have five hearts, is greatly restricted by the metallic structure that constitutes the horseshoe nailed to the bottom of the hoof. Therefore, the idea of letting horses run barefoot is becoming increasingly popular and accepted even among seasoned horsemen.

Another problem with traditional horseshoes is the condition generally referred to as “contracted heel,” which often manifests itself after repeated shoeings of the horse. In its natural state the hoof expands as it grows; that is, its footprint, if allowed to grow naturally, becomes larger over time as the hoof increases in thickness because of its roughly frustoconical shape. However, the rigid metal structure of the horseshoe nailed to the hoof does not permit this expansion and the hoof therefore grows in thickness while retaining essentially the same footprint. This leads to the contracted heel condition, which can severely harm the horse to the point of rendering it lame.

In an effort to provide a better means of hoof protection, various kinds of horse pads, shoes and boots have been developed, each with particular features designed to provided specific improvements. Horse boots made of resilient polymeric materials have been particularly relevant in recent years to provide protection and at the same time the flexibility required for the hoof to expand and contract between steps, thus allowing the natural physiological function addressed above. The difficulty has lied in providing a durable attachment of the boot to the hoof without resorting to the traditional use of nails. To that end, all kinds of strapping devices have been used in the art, such as laces, flexible straps, elastic straps, cables connected to a buckle or other tensioning device mounted on the boot, and gators wrapped around the pastern. In addition, various forms of attachment using adhesives have been developed with varied degrees of success.

In particular, synthetic horse shoes have also been attached with success using an adhesive, either directly on the hoof or through an intermediate liner. See, for example, co-owned U.S. Ser. No. 12/401,107 and U.S. Pat. No. 4,892,150 (Thoman). This approach has shown to be remarkably reliable, even for horse racing, when the shoe is properly installed and the adhesive is allowed to cure completely before the horse presses on the shoe. As a further improvement in the art, the present invention is a shoe that incorporates all advantages of a glued-on resilient structure with the simplicity and stability of a traditional metallic horseshoe. The shoe can optionally be glued or nailed to the hoof without material difference in its performance and durability.

### SUMMARY OF THE INVENTION

The invention is a horse shoe adapted for installation with either glue or nails. A structure in the shape of a horseshoe with a conventional open heel provides the support for the hoof bearing on the ground, but the two open portions at the heel are connected by means of a cantilevered bridge shaped like an inverted V projecting inward toward the interior of the horseshoe. As a result of the connection, the bridge also provides a spring-like tensioning mechanism urging inward the heel portions of the horseshoe after they are expanded to fit the hoof. The shoe includes an upper, preferably integrally formed with the horseshoe, that has side walls attached to the rear portion of the lateral edge of the horseshoe that can be flexed as needed to conform to the shape of the hoof to which the shoe is fitted. A toe clip is present in the front portion of the shoe and two side tabs are also preferably included as anchors for gluing the shoe and for aligning the shoe with the hoof for nailed-on applications. The side walls and the top surface of the horseshoe include perforations and connected recesses, respectively, for promoting the distribution of the glue applied during fitting and for increasing the contact surface with the layer of glue bonded to the hoof of the horse when the shoe is so installed. The bottom of the horseshoe includes notches corresponding to the location for placement of nails in conventional shoeing applications.

A softer pad made of foam material is preferably attached to the inner portion of the shoe's top surface in order to contain the spreading of glue during its application to the sidewalls and the outer portions of the top surface of the horseshoe. Because of the roughly concave shape of the frog at rest, excessive glue could accumulate and harden under the frog during application of the horse shoe, which in turn could create discomfort or even injury to the frog or hoof as a result of the repeated pressing of the hoof against it. In addition, even when the glue is applied correctly, the inner void left between the frog and the surface of the shoe when no pad is used could cause a similar problem as a result of the accumulation of debris received though the opening in the bottom of the shoe.

When the shoe of the invention is used as a glued-on item, prior to fitting the interior surfaces of the upper and the top surface of the horseshoe are lined with bonding material, preferably after roughing up the surfaces for better adhesion. The shoe then is fitted to the hoof of the horse from the front by opening the side walls of the upper and the heel portions of the horseshoe and placing the shoe in place. Because of the shape of the upper and the spring-like action of the bridge, the shoe conforms readily to the side surfaces of the hoof and stays in place while the bonding material is hardening even without pressing against it. The entire fitting process can be carried out very rapidly, in a few minutes.

Because the upper's side walls include perforations and the top surface of the horseshoe includes connected recesses that become saturated with a layer of well distributed glue during the process of attaching the shoe to the hoof, the amount of glue interposed between the shoe and the hoof is materially increased and the pad prevents its spreading to the area under the frog. So, the extent of surface contact between the shoe material and the glue is also increased, thereby improving the strength of the bond between shoe and hoof.

For nailed-on applications the side walls of the shoe are removed to make room for clinching the nails driven in conventional manner through the horseshoe and the hoof. The shoe then is aligned with the hoof by sliding the horseshoe backward from the front until the hoof presses against the toe clip and the side tabs clamp the hoof. The heel portions of the horseshoe are expanded as necessary to align the notches in the bottom surface as necessary for the correct placement of the nails with respect to the footprint of the hoof. A wedge insert adapted to widen the gap in the heel of the horseshoe is preferably used during the installation of the shoe and removed thereafter.

According to another aspect of the invention, the shoe in conjunction with various wedge inserts of different size can be used, especially in the nailed-on version, to prevent and/or correct the contracted heel condition that horses sometimes develop from repeated shoeing. To that end, the wedge insert is left in the horseshoe after installation, preferably fastened to the horseshoe, and it is replaced periodically with larger inserts commensurate with the corresponding growth of the hoof's footprint. The inserts can also be used with either nailed or glued horse shoes to limit the vertical relative displacement of the two ends of the horseshoe, which can be useful when a horse used to the rigid metal horseshoe is first switched to plastic, more flexible shoes that allow the two sides of the hoof to move more independently.

Various other advantages will become clear from the description of the invention in the specification that follows and from the novel features particularly pointed out in the appended claims. Therefore, this invention includes the features hereinafter illustrated in the drawings, fully described in the detailed description of the preferred embodiments and particularly pointed out in the claims, but such drawings and description disclose only some of the various ways in which the invention may be practiced.

### BRIEF DESCRIPTION OF THE DRAWINGS

FIG. 1 is a perspective view of the front-left side of a horse shoe according to the invention.

FIG. 2 is a top view of the horse shoe of FIG. 1.

FIG. 3 is a bottom view of the horse shoe of FIG. 1.

FIG. 4 is a front view of the horse shoe of FIG. 1.

FIG. 5 is a rear view of the horse shoe of FIG. 1.

FIG. 6 illustrates the vertical offset in the heel portions of the shoe of FIG. 1 made possible by the resilient material used to manufacture the shoe.

FIG. 7 is a side view of the shoe of FIG. 1.

FIG. 8 illustrates the shoe of FIG. 1 glued onto the hoof of a horse.

FIG. 9 is a bottom view of the shoe of FIG. 8 to show the expanded heel portions of the horseshoe pressing on the hoof.

FIG. 10 is a top view of the shoe of FIG. 2 with a pad attached to the top surface of the horseshoe.

FIG. 11 is a rear view of the shoe of FIG. 10.

FIG. 12 is a perspective view of the shoe of FIG. 10 after the side walls have been cut off for nailed-on installation.

FIG. 13 is a perspective view of a wedge insert used to set the proper degree of widening of the heel portions of horseshoe of FIGS. 1 and 10 for the purpose of facilitating its nailed-on installation.

FIG. 14 is a top view of the insert of FIG. 13.

FIG. 15 is a bottom view of the insert of FIG. 13.

FIG. 16 is a front view of the insert of FIG. 13.

FIG. 17 is a rear view of the insert of FIG. 13.

FIG. 18 is a view of the shoe of FIG. 10 with the insert of FIG. 13 partially introduced into the horseshoe.

FIG. 19 is another insert illustrating a larger wedge dimension.

FIG. 20 is an alternative wedge insert configuration with a backing for connection to heel of the horseshoe in order to prevent the release of the insert during use.

FIG. 21 shows the wedge insert of FIG. 20 installed on the shoe of FIG. 10.

FIG. 22 illustrates a modified shoe with rounded slots for receiving a preferred alternative insert.

FIG. 23 illustrates the preferred wedge insert adapted to fit into the slots of FIG. 22.

FIG. 24 is a top view of the insert of FIG. 23.

FIG. 25 is a bottom view of the insert of FIG. 23.

FIG. 26 is a front view of the insert of FIG. 22.

FIG. 27 is a rear view of the insert of FIG. 23.

FIG. 28 illustrates an insert in the shoe of FIG. 18 nailed to the hoof according to the invention.

FIG. 29 illustrates another wedge insert adapted to fit into the slots of FIG. 22.

FIG. 30 illustrates yet an additional wedge insert adapted to fit into the slots of FIG. 22.

FIG. 31 illustrates a metal plate incorporated into the shoe of the invention in order to prevent loosening of the nails in nailed-on applications.

FIG. 32 illustrates a shoe made of a transparent material.

### DETAILED DESCRIPTION OF THE PREFERRED EMBODIMENT

As used herein, the term “horse boot” is intended to refer to a hoof-wear article that wraps substantially completely around the hoof of the horse and often also includes a gaiter attached to the pastern. The term “horse shoe” is used to describe a lower profile item, without a gaiter, that may wrap only partially around the hoof of the horse. The term “sole” is defined to refer only to that part of a horse boot or shoe that covers entirely the underside of the hoof. By contrast, the term “horseshoe” is defined to refer to a structure, made of any material, that is substantially in the form of a conventional iron horseshoe that has an open heel and an interior open area corresponding substantially to the interior underside of the hoof of the horse. As described with reference to the present invention, the heel portions of the heel are connected by a bridging structure. Finally, the term “resilient” is used in this specification to mean capable of deforming when subjected to a bending, compressing or stretching force and of returning to the original condition when such force is released. In view of the fact that most materials exhibit some degree of resilience, for the purposes of this disclosure and of the claimed invention the term resilient is limited to materials that can be bent by at least 30 degrees without suffering any permanent deformation.

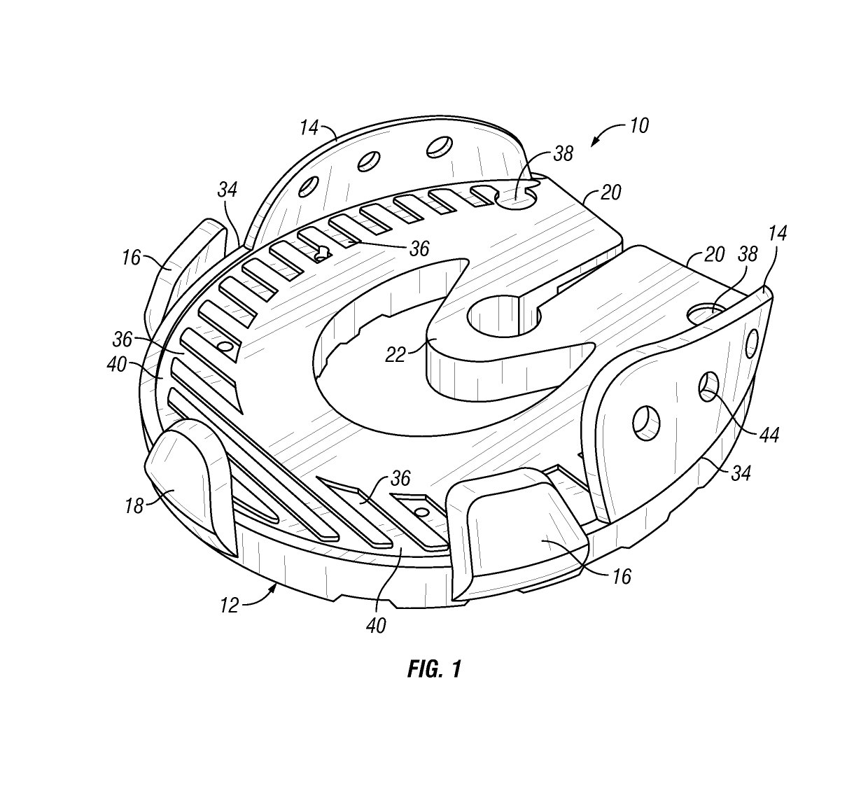

Referring to FIGS. 1-5, the horse shoe 10 according to the invention is illustrated. The same reference numerals and symbols are used to refer to the same structural parts throughout the drawings. The shoe 10 comprises a polymeric bottom part that is essentially a horseshoe 12 attached to an upper that includes two rear side walls 14, two front lateral tabs 16, and one toe clip 18. The horseshoe 12 has two legs with heel portions 20 at the rear of the shoe from which a connecting bridge 22 is cantilevered inward toward the open center 24 of the horseshoe. The bridge 22 is shaped roughly like an inverted V attached to the heel portions 20 of the horseshoe so as to provide a connection between them through the cantilever structure of the bridge. As a result of this configuration, the bridge 22 and the open heel portions 20 of the horseshoe structure define a gap 26 that can be widened by pulling apart the heel portions 20 and the side walls 14 of the shoe. The resilient (preferably polymeric) material used for the shoe 10 allows such deformation in order to conform to the natural expansion and contraction of the hoof between steps. Similarly, the two heel portions 20 of the horseshoe 12 can be bent in opposite vertical directions to offset one with respect to the other, as illustrated in FIG. 6, which allows the shoe 10 to conform to the normal deformation of the hoof when stepping on irregular terrain during use.

As mentioned, the horse shoe 10 can be glued or nailed on the hoof at the option of the user. The resulting performance has been found to be essentially the same, thus giving the user the freedom to follow his/her preferred method of installation while retaining all advantages of a light-weight resilient horse shoe. The use of the invention as a glued-on shoe is discussed first.

Because of the resilience of the material, the widening of the rear portions 20 causes the bridge 22 to act as a spring urging the horseshoe 12 toward its rest position (i.e., advantageously narrowing the gap 26 when the heel portions 20 are opened to fit the shoe to the hoof or opening of the gap toward its rest position when the heels are compressed toward each other). This feature facilitates the fitting of the shoe for gluing purposes by making it possible to widen the horseshoe 12 for ease of mounting and then providing inward pressure on the hoof for a stable connection while the glue cures. This is a very important feature because it is essential for the quality of adhesion that the shoe remain stable on the hoof during the curing process, which is enabled by the compression provided by side walls 14 on the hoof as a result of the contracting force exerted by the bridge 22 on the expanded heel portions 20. The reverse spring action of the bridge 22 (urging the expansion of the gap 26) is also useful because it allows the heel portions 20 of the shoe to follow and facilitate the natural lateral compression and expansion of the hoof's heel, a freedom of movement that is totally absent with the use of metal horseshoes.

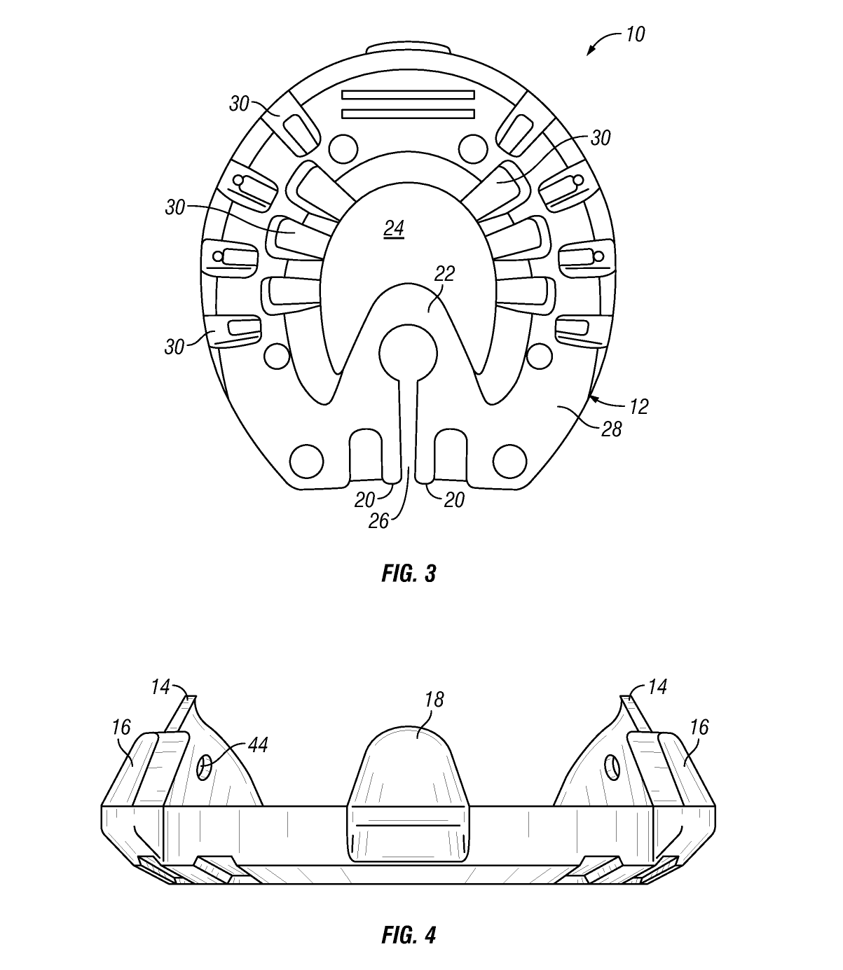

As seen in FIG. 3, the horseshoe 12 of the shoe 10 includes a bottom surface 28 that is preferably treaded for traction like the underside of a conventional metal horseshoe. The treads may take different forms, as best suited for the conditions under which the shoe is expected to be used. For example, the surface 28 may feature tread notches 30, as seen in the figure, and/or tread protrusions (not shown). In the preferred embodiment the bottom surface 28 of the shoe (e.g., the underside of the horseshoe 12) comprises an inner row as well as an outer row of notches 30 on each side of the horseshoe. As mentioned above, the shoe 10 does not have a sole, as conventional horse boots do, but only the platform 12 in the shape of a horseshoe and intended to function as such. That is, the horseshoe 12 is designed so as to bear the horse's weight as the shoe contacts the ground, thereby providing traction in the same manner as a traditional iron horseshoe would. However, contrary to the effect produced by a stiff iron horseshoe, the ground pressure exerted on the polymeric horseshoe 12 of the invention is not only transmitted to the hoof but also allows its lateral deformation. Because of the flexibility of the polymeric material used in the manufacture of the shoe, the open bottom of the shoe and the open rear portion (the gap 26) of the horseshoe allow the shoe's cyclical deformation in function of ground pressure with the attendant benefits to the hoof and frog, which are able to follow their natural cyclical expansion and contraction as the horse repeatedly steps on the ground. In addition, the presence of the bridge 22 provides a frog support that guarantees the frog's compression (and its corresponding pumping action) when the hoof meets the ground even though the hoof is elevated with respect to ground level (due to the thickness of the horseshoe 12).

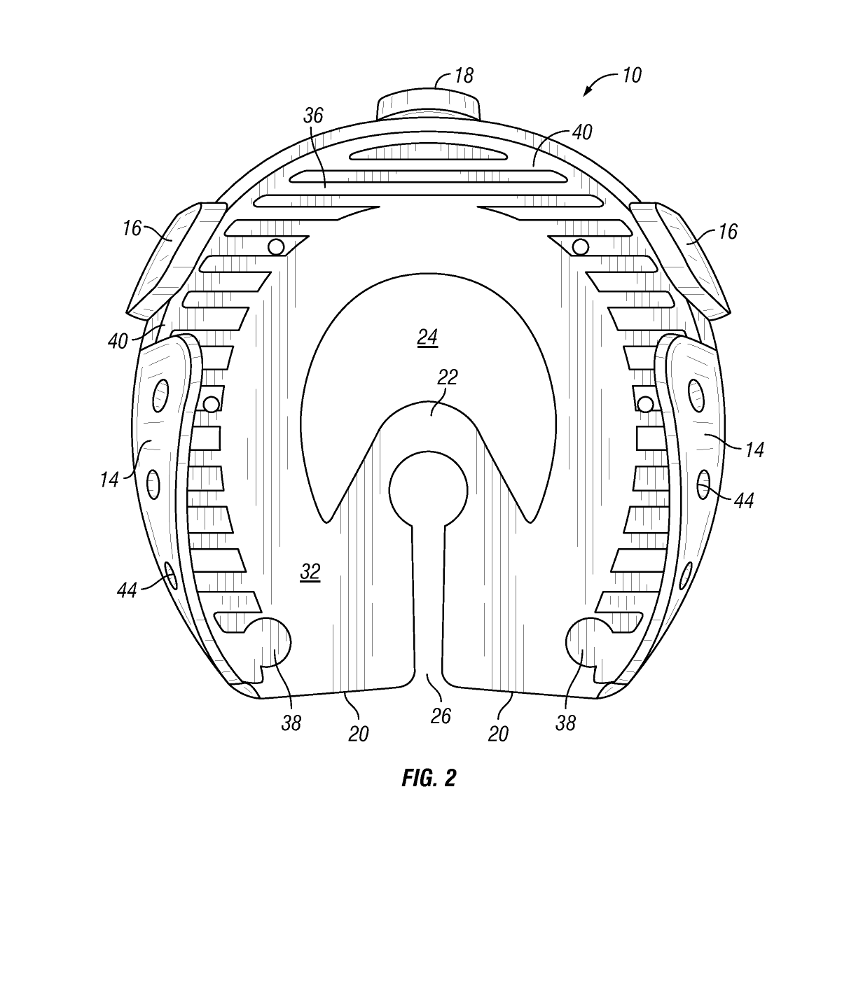

Referring back particularly to FIGS. 1 and 2, the top surface 32 of the horseshoe 12 is connected to the upper's side walls 14 along the rear portions of its outer edge 34, preferably integrally by means of a unitary construction, leaving a sufficiently large portion of the surface 32 open for gluing to the bottom of the hoof of the horse. Preferably interconnected recesses 36 and notches 38 may be formed in the surface 32 in order to increase the area of adhesion and thereby enhance the strength of the bond with the bottom of the hoof of the horse. A peripheral channel 40 running substantially along the entire top surface 32 of the horseshoe 12 connects all recesses and notches to facilitate the even distribution of adhesive. Here again, different shapes of recesses and/or notches may be used as deemed best for a particular application so long as an interconnected grid pattern is established.

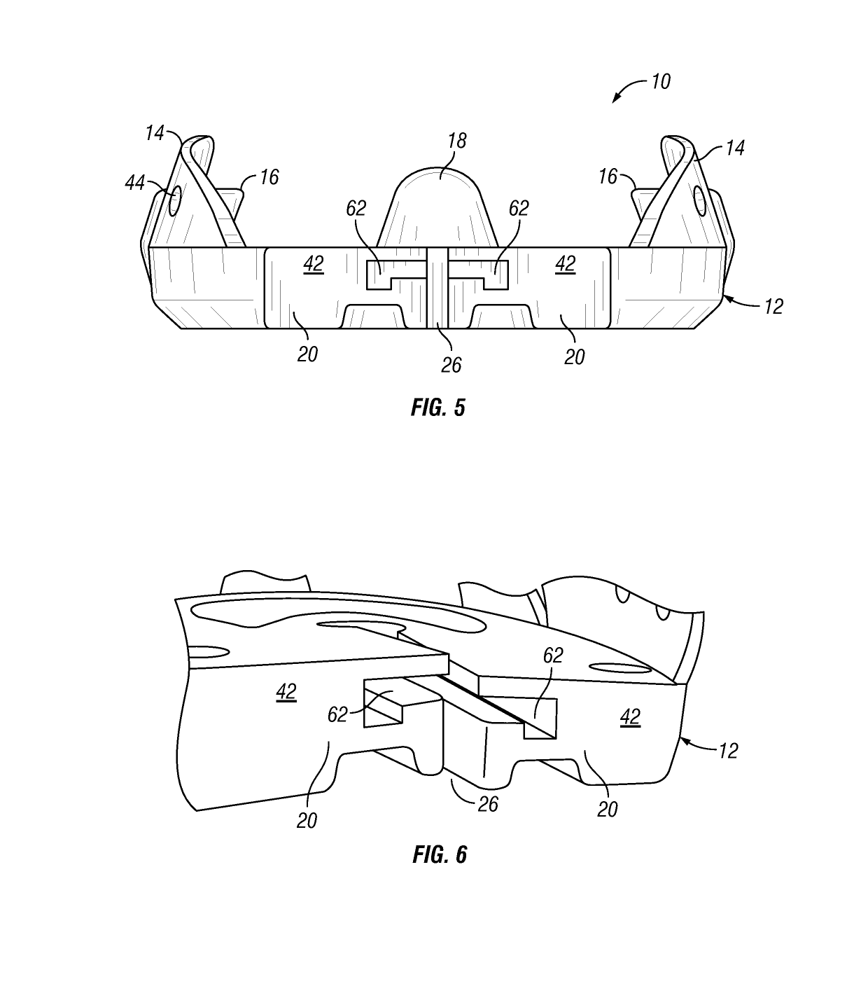

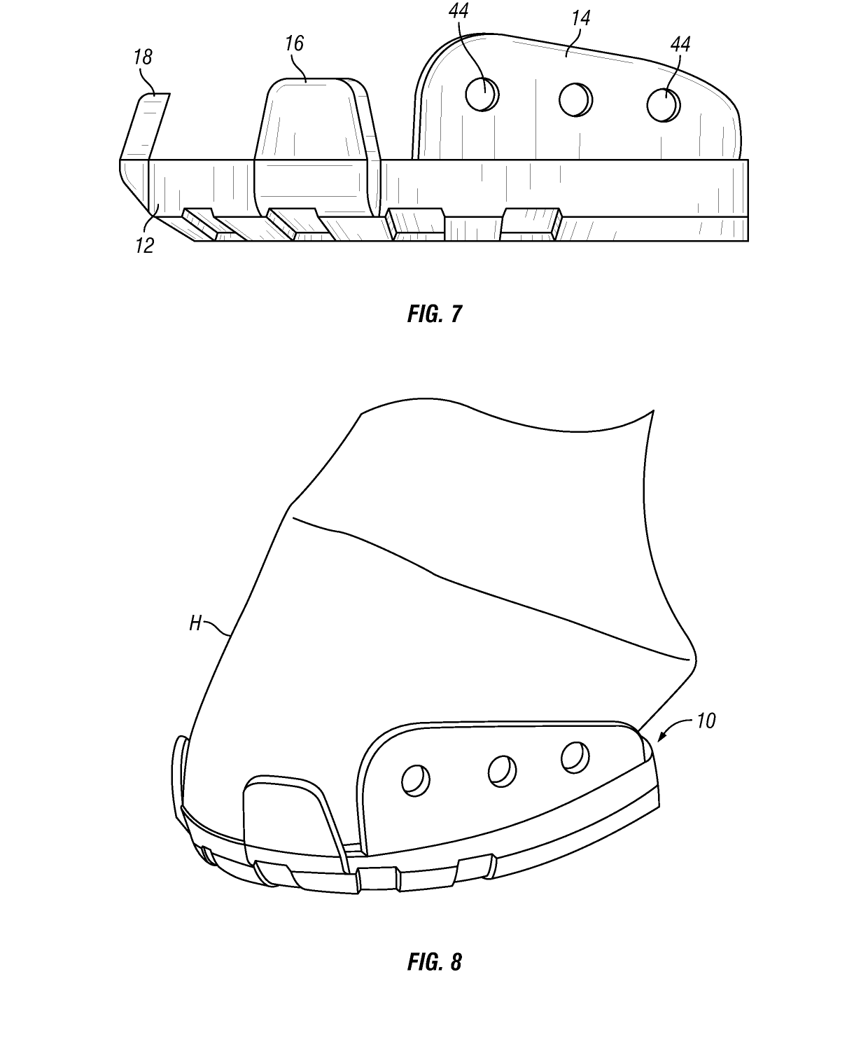

The side walls 14 of the upper cover approximately the rear half of each side of the shoe 10 and slope downward toward the heel, as seen particularly in FIG. 7, where the shoe has no upper and the thickness of the heel portions 20 define a substantially plane vertical wall 42 (see also FIGS. 4 and 5). The upper in the front portion of the shoe includes two side tabs 16 and a toe clip 18 to register the hoof during installation of the shoe and provide additional structure for supporting and anchoring the front of the hoof to the shoe. Multiple perforations 44 are preferably provided in the side walls 14 as additional flow channels for the adhesive to spread through when the shoe 10 is glued on. Each cured amount of glue flowed out of the perforations 44 provides a rivet-type anchor to the layer of adhesive that bonds the side walls 14 to the exterior surface of the hoof. The specific purpose of each upper item will become clearer below when the optional method of shoe installation is described.

Because of their separation, the side walls 14 of the upper can move independently of one another, so that maximum conformance to the shape of the hoof may be obtained when the shoe is fitted to the horse and the side walls clamp the sides of the hoof. Also, the backward sloping side walls are bent inward to provide some built-in inward pressure against the sides of the hoof in addition to the pressure exerted by the bridge 22 after the horseshoe 12 has been expanded to fit the shoe on the hoof. In order to ensure this functional feature of the invention, the shoe is designed and molded with a narrower gap 26 than required to fit it to the average hoof for which it is intended. Thus, the portions 20 of the heel have to be expanded for fitting, which in turn enlarges the gap 26 straddled by the resilient V-shaped bridge 22 and causes it to remain in a loaded condition, generally urging the heel portions 20 of the horseshoe 12 inward while mounted to the hoof. All shoe constituents are sufficiently resilient to permit bending under hand pressure and to conform to the shape of the hoof.

These features have been found to be critical because they prevent the detachment of the shoe on impact, a problem experienced with glued-on horseshoes that are either unconnected or rigidly connected at the back end. In particular, the resilient connection provided by the bridge 22 allows the above-described cyclical expansion/contraction of the shoe while also forcing all parts of the shoe to correspondingly flex and move with the hoof as a single unit, thereby avoiding the stresses that cause prior-art glued-on boots and shoes to detach after brief periods of use. The bridge 22 needs to be sufficiently resilient to allow the expansion of the horseshoe to always conform to the shape of the hoof as the hoof expands and to maintain such conformance when the hoof contracts, so that stresses between the hoof and the horseshoe are avoided. To that end, the use of an elastic polymeric material such as a resilient urethane is ideal. In contrast, more rigid materials such as metal and rigid plastics were found not to allow the conforming behavior necessary for a lasting bond between the horseshoe 12 and the bottom of the hoof.

In use, the shoe 10 may be installed using only glue to secure it to the hoof. After placing an appropriate amount of bonding material on the interior surface of the side walls 14, the lateral tabs 16 and the toe clip 18 of the upper, and throughout the top surface 32 of the horseshoe 12, the shoe is slipped on the hoof from the front of the hoof while keeping the side walls open until the front of the hoof buts against the toe clip 18. It was found that an amount of glue appropriate to form a layer between 1.5 and 3 mm in thickness (excluding the thickness of the recesses and notches) is ideal. Though typically not necessary, additional bonding material may be applied between the hoof and the horseshoe and/or the edges of the upper in sufficient quantity to assure complete coverage of the abutting surfaces and penetration of the glue into the recesses 36 and the perforations 44. The shoe is then kept firmly in place for the time required for the bonding material to set. Currently available polyurethane glues, such as the product marketed under the mark Adhere by the Vettec Company of Oxnard, Calif., cure in less than 90 seconds. Therefore, the shoe need not be held in place long before it is firmly attached to the hoof. The entire fitting process may be accomplished comfortably in less than five minutes. FIG. 8 illustrates the conforming features of the shoe glued onto the hoof of a horse. FIG. 9, in particular, shows the expanded condition of the gap 26 in the horseshoe 12 after the shoe is fitted to the hoof H of a horse, which clearly illustrates the retention function provided by the resilient bridge structure.

It has been found that excessive usage of glue may cause an accumulation of hardened material along the inner perimeter of the top surface 32 of the horseshoe 12. This results from the fact that at rest the frog defines a concavity in the underside of the hoof where excess glue material can accumulate during the process of installing the shoe, which is done with the hoof bent up in the air with no pressure applied to it. If such accumulation of glue occurs and hardens, it creates a layer of material that interferes with the natural movement of the frog when pressure is applied through the hoof. The same can occur during use even without glue accumulation if the horse walks on mud or loose debris that can penetrate the open bottom of the horseshoe and find its way into the space between the surface of the horseshoe and the frog.

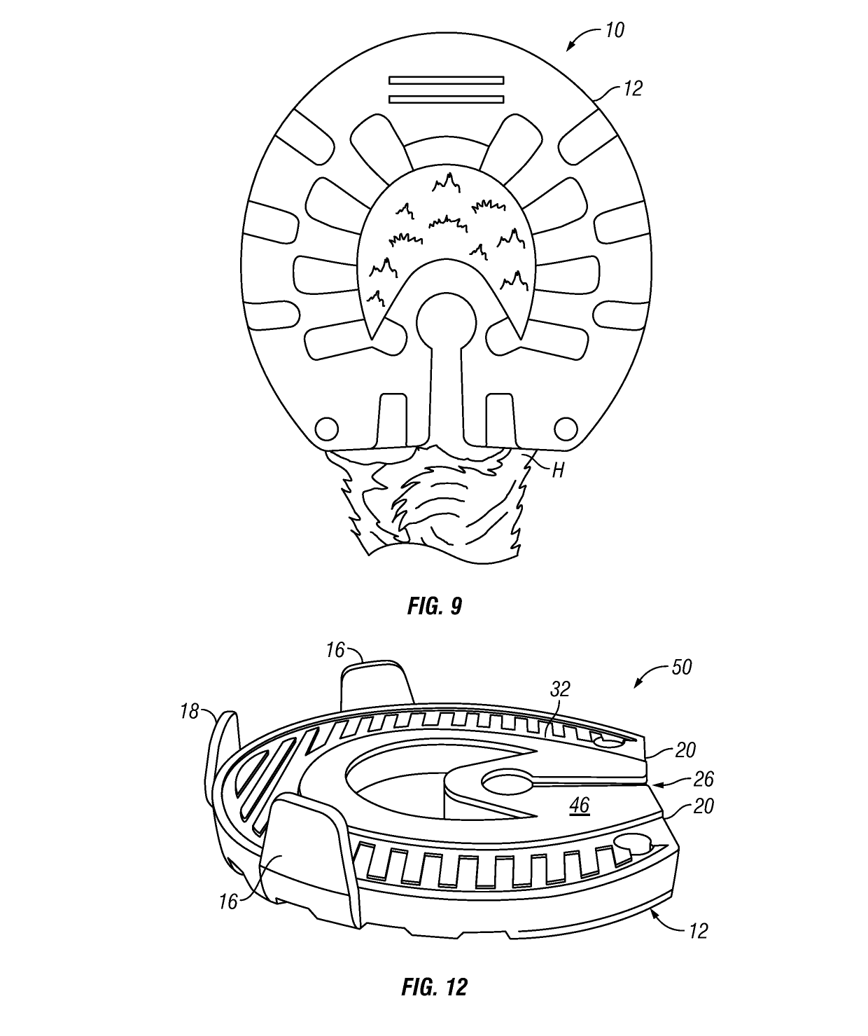

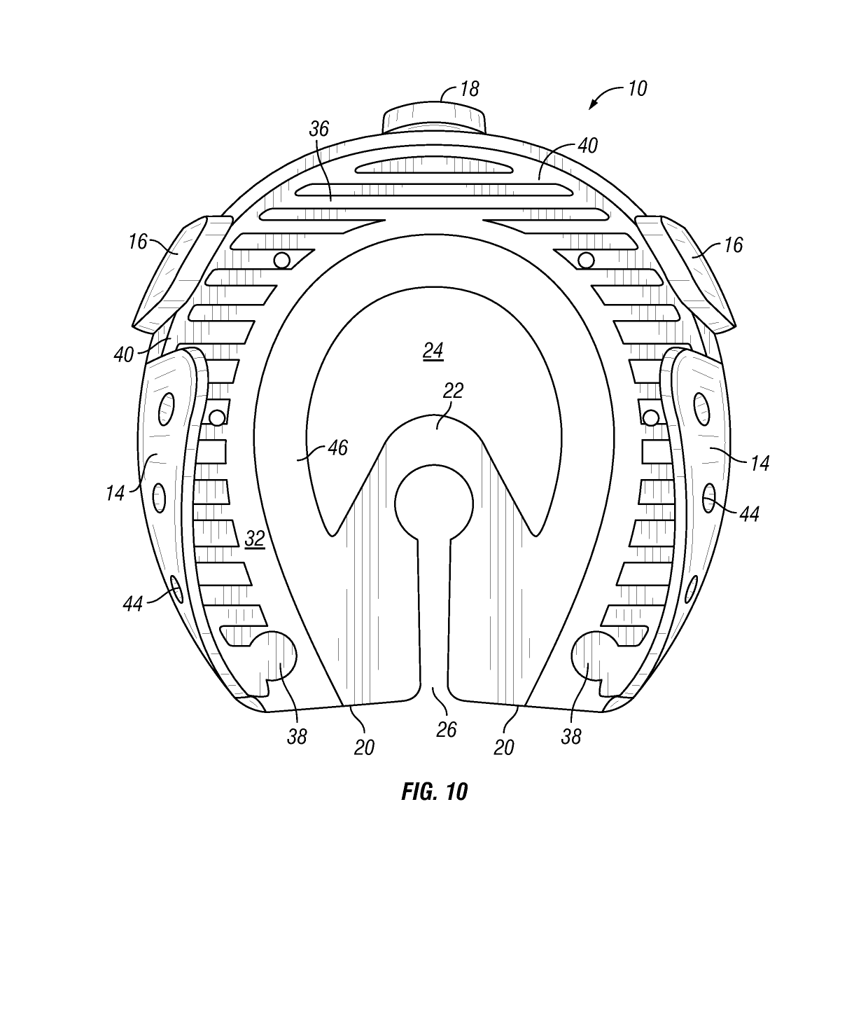

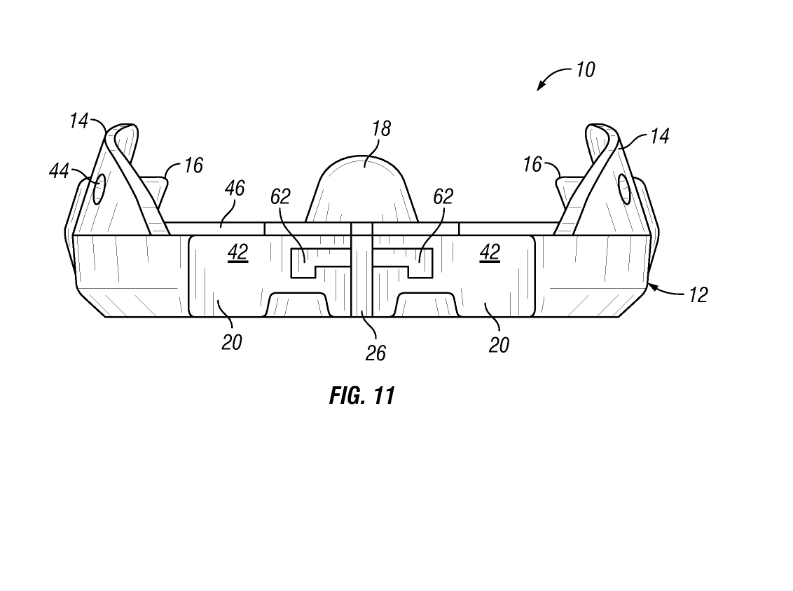

In view of the foregoing, the preferred embodiment of the invention is fitted with a resilient foam pad 46, as illustrated in FIGS. 10 and 11, that prevents the accumulation of glue during the process of installing the shoe as well as the accumulation of debris afterward. The preferred pad is a ring along the inner region of the surface 32 of the horseshoe 12 made of a polyurethane foam layer about ⅛ of an inch thick. The pad 46 is preferred for both glued-on and nailed-on applications because the accumulation of debris can be a problem in both. Note that the general width of the annular surface 32 is greater than the width of the typical metal horseshoe (about 1.5 inches versus about ¾ of an inch); therefore, the horseshoe 12 overlaps to some extent with the frog, thereby forming the open space that can retain debris and create the problems mentioned above.

For glued-on applications, the shoe of the invention has been fitted to many horses using the Sole-Guard (Adhere) adhesive and tested for long periods of time without failures and with no sign of separation of the glue from the hoof, in contrast with the experience with previous glued-on boot configurations. This result was obtained in spite of the normal aging and cell replacement of the hoof, which is believed to have caused the outer layers of the hoof to separate from the bonding material in previous glued-on boots. This apparently maintenance-free use of the shoe of the invention renders it ideal for recreational riding as well as endurance events and races during which it is particularly important to be able to ride without shoe failures.

As indicated above, at the option of the user the shoe 10 of the invention is suitable for alternative fitting by nailing it to the hoof, just like a conventional iron shoe. This alternative may be preferable to a user who wishes to combine the novelty and advantages of a resilient polymeric horseshoe with the traditional installation practice of nailing the horseshoe to the hoof. For this application, the shoe 10 is modified by removing the sidewalls 14 from the shoe. They can simply be cut with a knife or any other instrument to produce the modified shoe 50 shown in FIG. 12. Without the side walls 14, the shoe 50 can be nailed in conventional manner by driving nails into the hoof from the bottom of the horseshoe 12 and then clinching them by bending down the pointed ends that protrude from the side of the hoof, an operation that would not be possible if the relatively high sidewalls 14 were left in place. For the same reason, the side tabs 16 are lower than the original height of the side walls 14 (no more than ¾ of an inch while the side walls 14 are preferably about one inch at their highest point over the top surface of the horseshoe 12). As seen in the bottom view of FIG. 3, each side of the horseshoe 12 has four notches 30 from where nails can be driven at an angle through the resilient material and hoof, so as to emerge from the hoof's side wall for clinching in the same manner of securing iron horseshoes. Three or four nails may be used on each side, as typically done with iron shoes. The result is a shoe that is just as secure as an iron horseshoe, but that is resilient and capable of deformation with all attendant advantages described herein.

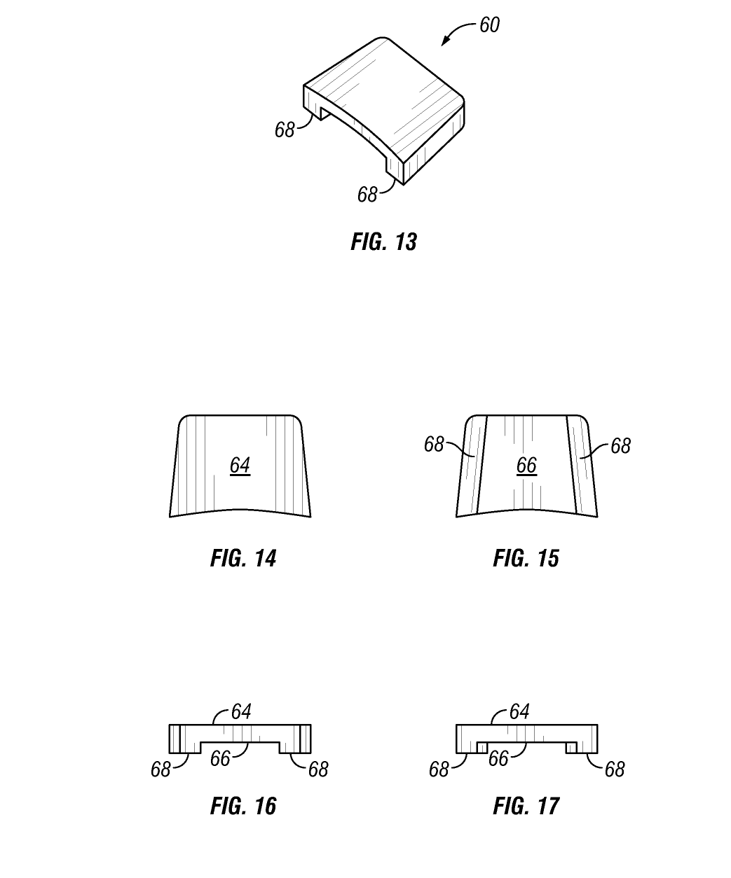

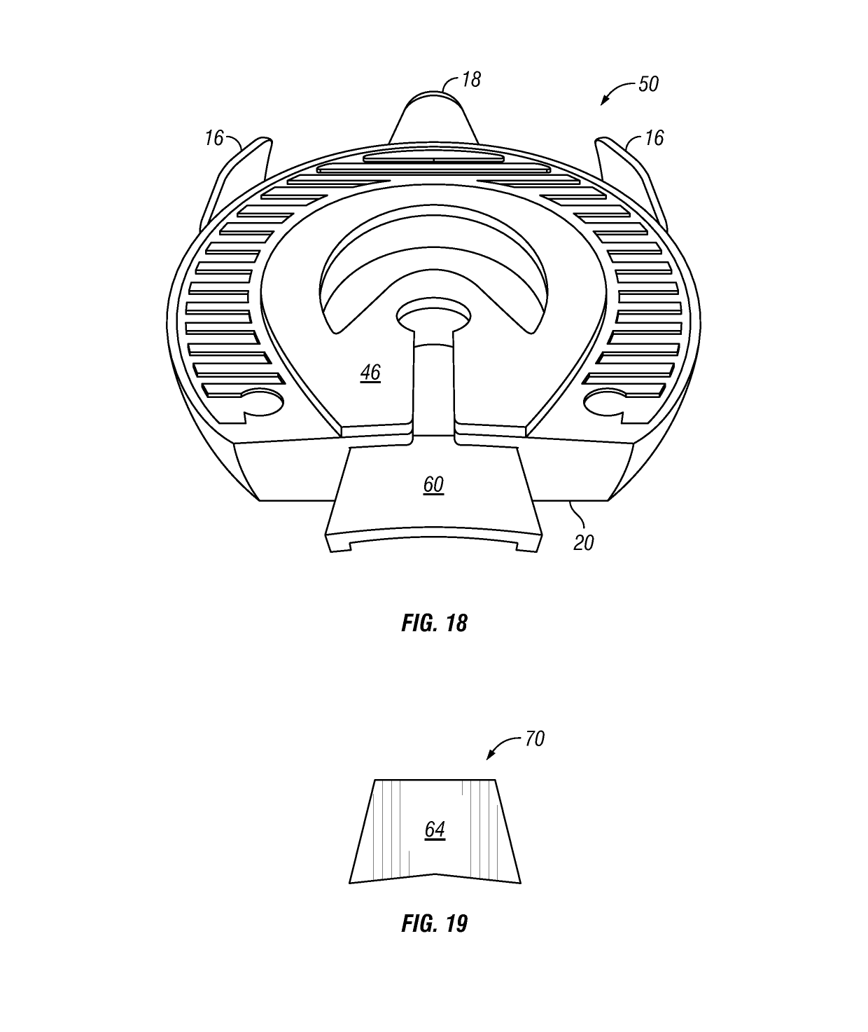

However, when the user choses to nail the shoe to the hoof (rather than gluing it), an additional part is recommended to facilitate the installation. FIGS. 13-17 illustrate a wedge insert 60 adapted to fit into a longitudinal opening defined by a slot 62 in each side of the rear wall 42 at the heel of the horseshoe 12. See FIG. 5. The insert 60 has a flat top surface 64 and a corresponding flat bottom surface 66 bound by two converging rails 68 that define the wedge shape of the insert 60. The rails 68 are sized in cross-section so as to fit in the slots 62 of the horseshoe inward to provide a rigid connection between the heel portions 20. Because the back side of the insert 60 is wider than the front side (wedge shaped), the two heel portions are necessarily pried apart during the process by the amount necessary to conform to the size of the insert's back side fitted into the gap 26 through the slots 62. To that end, the insert 60 is made of a rigid material, such as a 65 Shore B durometry scale material, capable of withstanding the contracting force provided by the bridge 22 and the overall resilience of the shoe material. Various inserts of different wedge dimensions are preferably used in order to provide alternative choices for the amount of gap enlargement produced by the insert. FIG. 18 illustrates the insert 60 partially introduced into the slots 62 of the horseshoe 12. As one skilled in the art would readily understand, each insert needs to be sized so that it can be readily introduced into the slots 62 by manipulating the heel portions 20 of the horseshoe; therefore, the front ends of the inserts are about the same size while the back ends have a different width to define different wedge shapes, as illustrated the by alternative wedge insert 70 shown in FIG. 19. It is also understood that the forward portions of the slots 62 (not seen in the figures) need to be sized with sufficient width to accommodate the different wedge angles of all inserts intended for use with the horse shoe.

Because the shoe 10 of the invention is shaped so as to require the expansion of the heel portions 20 to cause the side walls 14 to press against the hoof during glued-on fitting, the horseshoe 12 tends to be narrower than the footprint of the hoof when the side walls are cut off for nail-on installation. Therefore, it would be nearly impossible for a farrier to expand the horseshoe 12 to the right size and keep it so open while driving the nails through it. Accordingly, an appropriately sized insert can be used to expand the heel portion of the horseshoe to the degree necessary to match the size that would be used with a conventional iron horseshoe. In addition, the two lateral tabs 16 and critically the toe clip 18 are advantageously used to position the horseshoe for nailing and to hold it in place as the nails are being hammered through the shoe and hoof. In order also to provide a stronger retaining action against slippage during use, the tabs 16 and clip 18 are preferably molded thicker (about twice as much) as the side walls 14. Once the shoe is installed on the hoof, the insert 60 can be removed simply by introducing gooseneck pliers in the gap 26 below and above the insert and pulling it out. If desired for any reason, another insert can similarly be added or removed from the back of the shoe attached to the hoof.

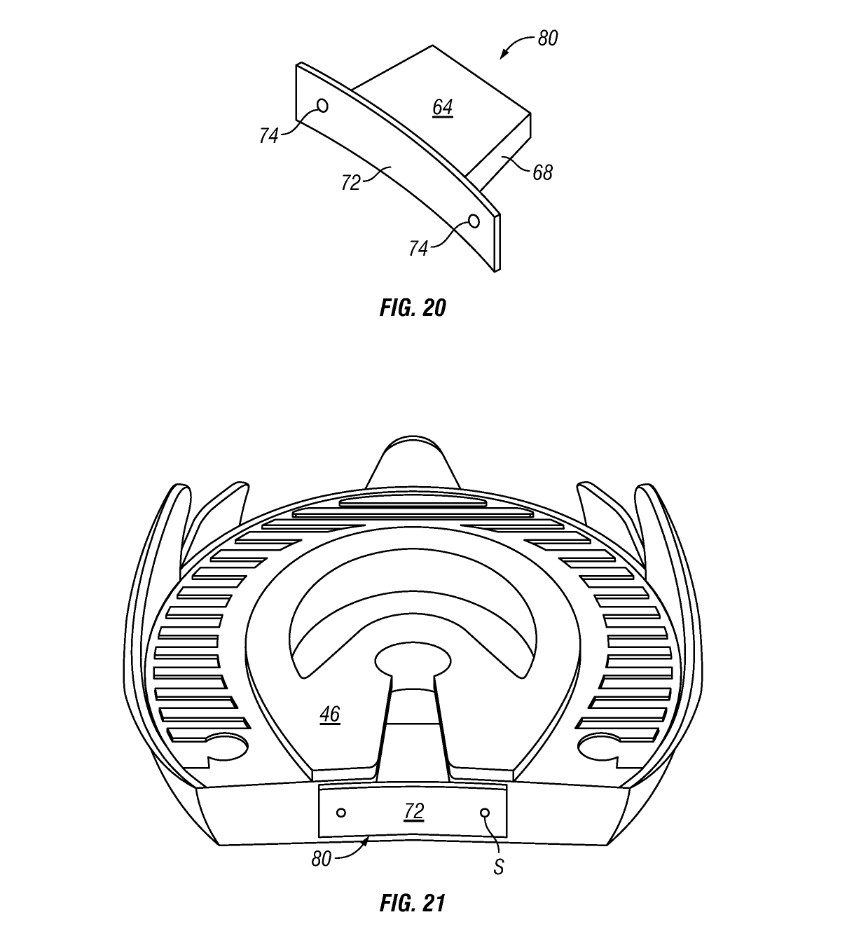

As a further advantage of the invention, the horse shoes 10 and 50 have been used with experimental success in an attempt to gradually improve the contracted-heel condition discussed above. It has been shown that by keeping the insert in the horseshoe during use and replacing it periodically with progressively wider wedges to accommodate and promote the natural expansion of the hoof's footprint as it grows the effects of contracted heel can be slowly reversed. To that end, the insert is preferably modified by the addition of a backing 72, as illustrated in FIG. 20. Such backing can be used to firmly retain the insert in place by driving two screws S into the horseshoe 12 through apposite alignment marks or perforations 74. FIG. 21 illustrates such a modified insert 80 installed on a shoe.

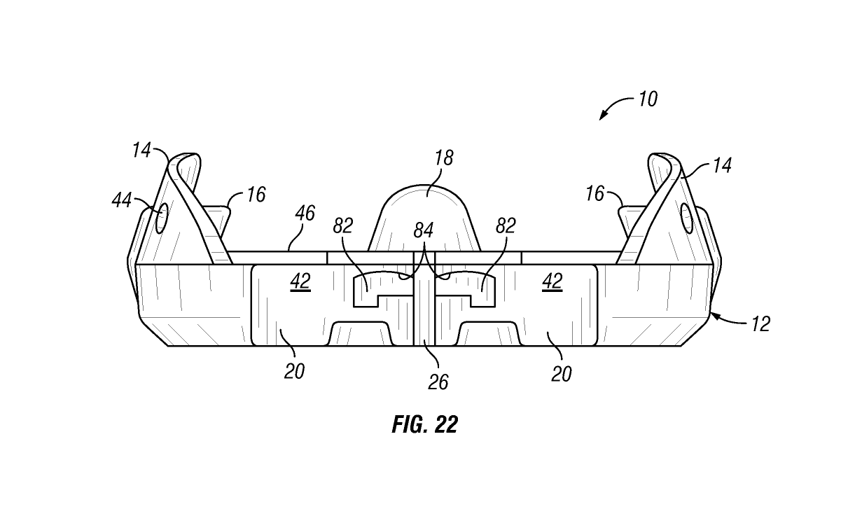

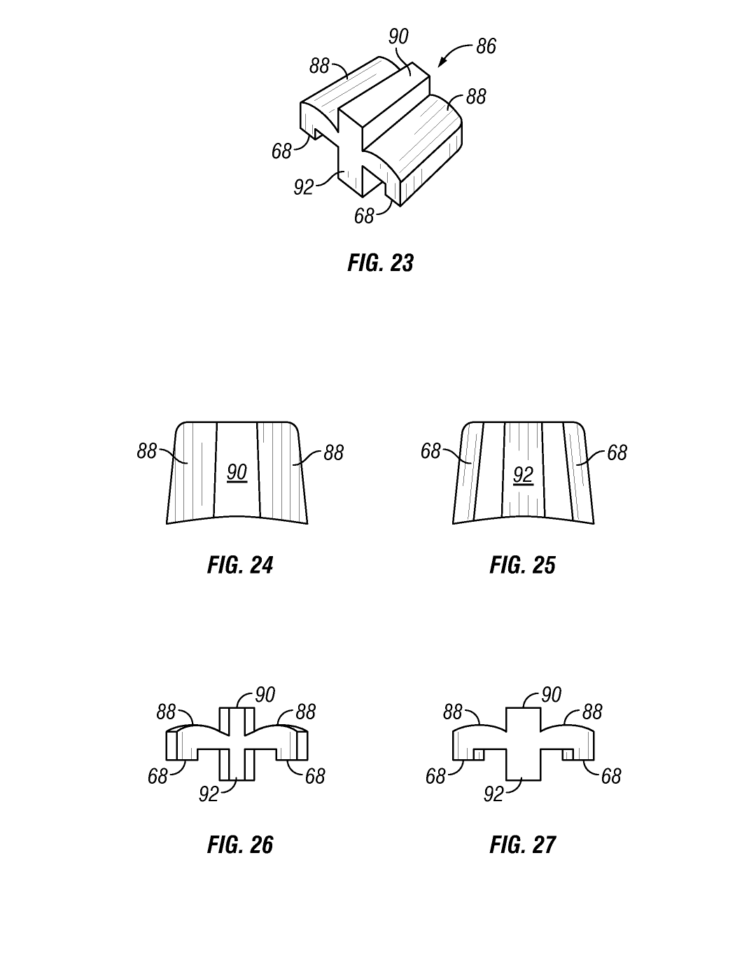

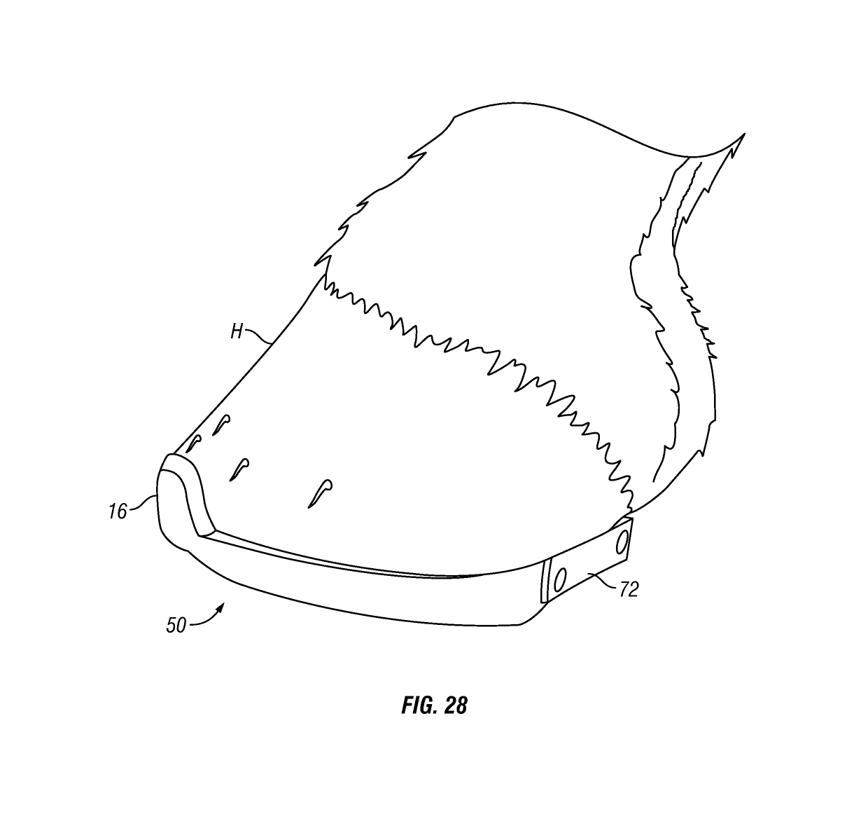

Continuous testing of the shoe of the invention has shown that different types of inserts are best for different applications. For instance, especially for the purpose of applications that require maximum independent vertical flexibility of the two horseshoe heel portions 20 for shock absorption purposes, it has been found that such additional flexibility can be achieved by removing some horseshoe material from its heel portions. This has been achieved preferably by increasing the cross-section of the slots 62 in the upper region of the slots. As illustrated in FIG. 22, such modified slots 82 have a curved, rather than planar, top surface 84. Accordingly, a different insert's cross-section is required for mating with the slots 82. FIGS. 23-27 show one embodiment 86 of such an insert. As seen in the prospective view of FIG. 23, the flat top surface 64 of the insert 60 of FIG. 13 is reshaped to form a top surface with two lateral extensions 88 having a curved profile. In addition, the center portion corresponding to the gap 26 when the insert is in place on the shoe may also be augmented to fill the spaces left open by the insert 60, thereby providing a continuous vertical support to the portion of the hoof bearing on the gap. To that end, a top section 90 and a bottom section 92 are added, preferably in integral manner, to the flat surface of the insert 60, both sections being narrower in front and wider in the back to conform to the wedge shape of the insert, as seen in the top, bottom, front and back views of FIGS. 24, 25, 26 and 27, respectively. As a result of these modifications, the insert 86 occupies the entire void space of the gap 26 and the slots 82, which may or may not be desirable depending on the application. If less rigidity and/or support is desired, either one or both sections 90 and 92 may be removed at will. Because of its additional functionality and versatility, the insert 86 of FIG. 23 with the backing 72 shown in FIG. 20 is preferred. FIG. 28 illustrates one such insert in a shoe 50 nailed to the hoof according to the invention.

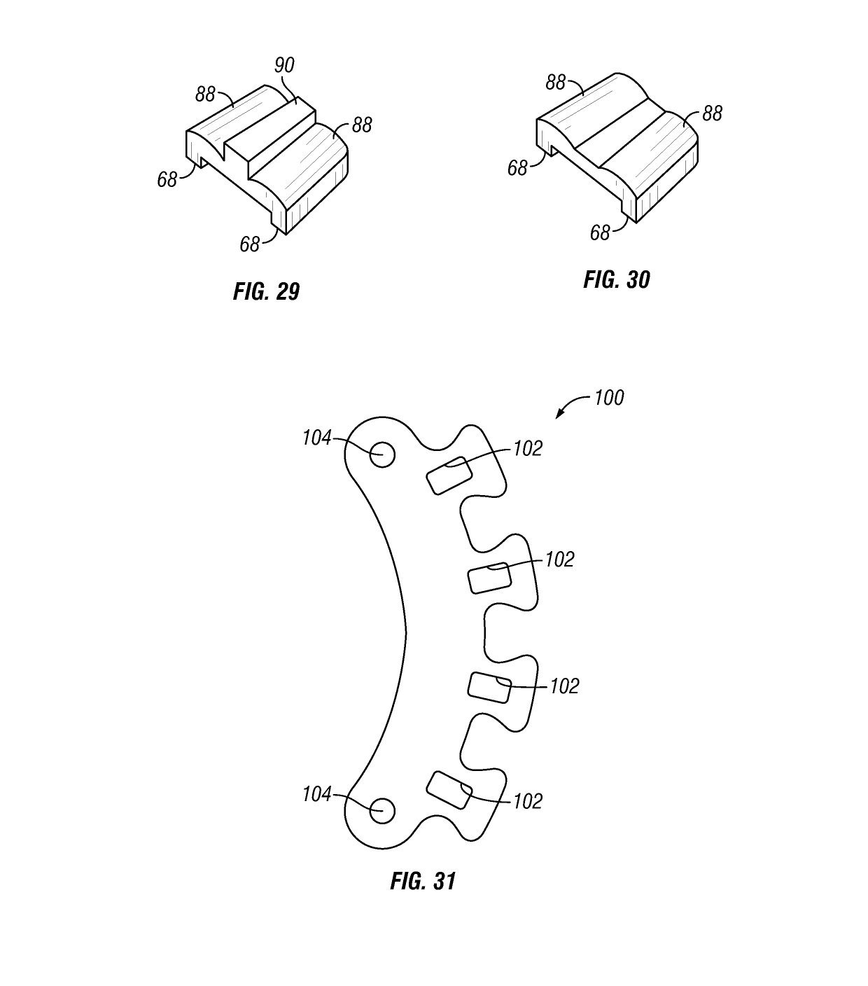

The horse shoes 10 and 50 have also been used advantageously to accustom horses to resilient shoes when they are first switched from iron horseshoes. Because of their rigidity, conventional horseshoes do not allow any torsion, which trains the hoof to an existence without any vertical displacement between the left and right sides of the hoof. When subsequently fitted with resilient shoes, the flexibility of the shoe can subject the hoof to excessive movement of the heel with attendant strain on the hoof. In such cases the use of the insert in the shoe of the invention is recommended because it provides some vertical displacement rigidity without blocking it altogether. Different inserts can be used over time to gradually allow increased flexibility and train the hoof to the greater freedom of movement associated with a resilient shoe. For example, the insert 86 could be used at first, followed by one without the bottom section 92, then one also without the top section 90, as respectively shown in perspective views in FIGS. 29 and 30, and finally without any insert at all.

Thus, a polymeric horse shoe has been disclosed that can be alternatively glued on the hoof, in the manner of other shoes recently developed in the art, or it can nailed on in the same fashion as a traditional iron horseshoe. In either case, the combination of the structural configuration and the resilient material used to fabricate the shoe allow the cyclical expansion and contraction of the hoof necessary for its natural blood-pumping function. The shoe is preferably molded as an item of unitary construction out of polyurethane material with hardness 90 on the Shore A durometry scale for testing materials' hardness according to ASTM D2240-00 standards. As the hoof grows and its footprint naturally expands with time, the horseshoe portion of the shoe can expand with the hoof, avoiding the contracted-heel problem often associated with iron shoed horses. In addition, the heel portions of the horseshoe are also free to move independently in the vertical plane, which allows the bottom of the shoe to conform to the natural deformation of the hoof when it steps on uneven ground. Finally, the combination of the shape of the horse shoe and the spring effect produced by the horseshoe bridge produces a shoe that inherently presses against and conforms to the hoof, which greatly enhances the shoe's stability during installation and use (in the glued-on mode).

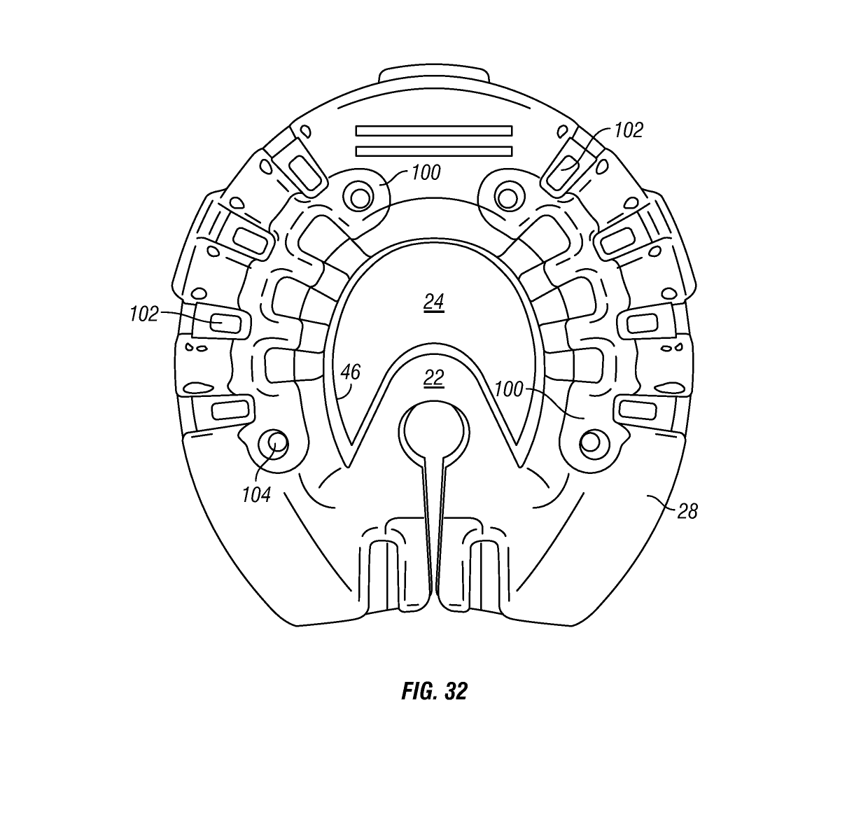

Finally, when the shoe of the invention is used in its nailed-on version, it has been found that over time the pounding of the hoof on the horseshoe 12 tends to drive the nails upward by wearing on the shoe's polymeric material. As a result, the clinch on the nails may become loose, which is undesirable. This potential problem has been corrected by incorporating metallic plates in the body of the horseshoe 12 with nail slots designed to provide a hard surface against which the nail head butts prior to clinching. Because the nail cannot wear down the metal plate, the clinch remains in place tight during the life of the shoe. FIG. 31 illustrates in plain view an exemplary structure of a plate 100 used for that purpose. The plate 100 includes nail slots 102 aligned with the outer row of tread notches 30 in the bottom of the horseshoe (see FIG. 3). The slots 102 are substantially rectangular and narrow enough to prevent through passage of conventional horseshoe nail heads. The larger dimension of each slot is disposed radially to provide flexibility in the way the nail is driven through by the farrier in order exit the side of the hoof at the right place. Two plates 100 are incorporated in minor image into the structure of the horseshoe 12 during the molding process. Perforations 104 matching the same geometry in the bottom of the horseshoe 12 are provided for alignment purposes during manufacture. Because of the lateral placement of the two plates 100, the horseshoe is stiffened in the direction from front to back without affecting its lateral and vertical flexibility, thereby retaining the advantages of the shoe of the invention. In order to further aid the process of nailing the shoe of the invention to the hoof, a transparent polymer may also be used, thereby allowing the farrier to see both the plates 102 and the hoof's white line, which is a traditional visual guidepost during horseshoeing. The bottom side of such a shoe is illustrated in FIG. 32

While the invention has been shown and described herein with reference to what are believed to be the most practical embodiments, it is recognized that departures can be made within the scope of the invention. For example, the plate 100 has been described as metallic, but any other rigid material with comparable strength and rigidity could be used alternatively, so long as capable of withstanding penetration of the nail heads when subjected to pounding by the hoof of the horse. The preferred materials have been disclosed as a urethane for the shell of the horse shoe, a polyurethane foam for the pad, and a polyurethane glue for gluing the shoe to the hoof; however, any other materials capable of equivalent performances would be acceptable. A similar remark applies to the wedge inserts, which can be made of any material strong enough to support the stresses produced by a horse's gallop. Therefore, the invention is not to be limited to the details disclosed herein but is to be accorded the full scope of equivalent articles.

1. A horse shoe for alternative glued-on or nailed-on installation comprising:
a horseshoe with heel portions defining a gap, a top surface of the horseshoe including a grid of recesses for receiving an adhesive material and a bottom surface thereof including a plurality of notches suitable for driving a nail therethrough;
an upper with two side walls attached to a rear lateral periphery of the horseshoe and folded inward to butt against a hoof of a horse wearing the shoe;
a toe clip attached to a front end of the horseshoe; and
a bridge connecting the heel portions of the horseshoe;
wherein the bridge is a resilient structure cantilevered inward from said heel portions of the horseshoe so as to urge closure of said gap when the horseshoe is expanded during fitting of the shoe.

2. The horse shoe of claim 1, further including a lateral tab attached to each side of a front lateral periphery of the horseshoe, said tab extending no more than ¾ of an inch above the top surface of the horseshoe.

3. The horse shoe of claim 1, wherein said side walls contain lateral perforations.

4. The horse shoe of claim 1, wherein said recesses for receiving an adhesive material are interconnected via a channel in the horseshoe.

5. The horse shoe of claim 1, wherein said horseshoe, side walls, toe clip and bridge are made of polyurethane of integral unitary construction.

6. The horse shoe of claim 1, wherein said horseshoe includes a bottom surface with treads.

7. The horse shoe of claim 1, further comprising a pad over an inner region of said top surface of the horseshoe.

8. The horse shoe of claim 1, further comprising a rigid plate incorporated into each side of said horseshoe, said plate including slots aligned with said notches in the bottom surface of the horseshoe.

9. The horse shoe of claim 8, wherein the horseshoe is made of transparent material.

10. The horse shoe of claim 1, further comprising a longitudinal slot in each of said heel portions, said slot being adapted to receive a lateral extension of a wedge insert.

11. A horse shoe for alternative glued-on or nailed-on installation comprising:
a horseshoe made of transparent material with heel portions defining a gap, a top surface of the horseshoe including a grid of recesses interconnected via a channel in the horseshoe for receiving an adhesive material and a bottom surface thereof including treads and a plurality of notches suitable for driving a nail therethrough;
an upper with two side walls attached to a rear lateral periphery of the horseshoe and folded inward to butt against a hoof of a horse wearing the shoe, said side walls containing lateral perforations;
a toe clip attached to a front end of the horseshoe;
a lateral tab attached to each side of a front lateral periphery of the horseshoe, said tab extending no more than ¾ of an inch above the top surface of the horseshoe;
a bridge connecting the heel portions of the horseshoe;
a pad over an inner region of said top surface of the horseshoe;
a rigid plate incorporated into each side of said horseshoe, said plate including slots aligned with said notches in the bottom surface of the horseshoe; and
a longitudinal slot in each of said heel portions, said slot being adapted to receive a lateral extension of a wedge insert;
wherein the bridge is a resilient structure cantilevered inward from said heel portions of the horseshoe so as to urge closure of said gap when the horseshoe is expanded during fitting of the shoe; and said horseshoe, side walls, toe clip and bridge are made of a urathane of integral unitary construction.

12. A method of fitting a horse shoe to a hoof of a horse, comprising the following steps:
providing a horse shoe that includes:
a horseshoe with heel portions defining a gap, a top surface of the horseshoe including a grid of recesses for receiving an adhesive material and a bottom surface thereof including a plurality of notches suitable for driving a nail therethrough;
an upper with two side walls attached to a rear lateral periphery of the horseshoe and folded inward to butt against a hoof of a horse wearing the shoe;
a toe clip attached to a front end of the horseshoe; and
a bridge connecting the heel portions of the horseshoe;
wherein the bridge is a resilient structure cantilevered inward from said heel portions of the horseshoe so as to urge closure of said gap when the horseshoe is expanded during fitting of the shoe.
applying bonding material on said top surface of the horseshoe and on interior surfaces of the side walls;
fitting the shoe to the hoof of the horse by stretching the heel portions to widen the gap in the horseshoe, sliding the horseshoe to press against the toe clip, and releasing the heel portions to cause the side walls to clamp around the hoof; and
holding the shoe in place until the bonding material has cured.

13. The method of claim 12, wherein the horse shoe includes a lateral tab attached to each side of a front lateral periphery of the horseshoe, said tab extending no more than ¾ of an inch above the top surface of the horseshoe, and said applying step includes applying said bonding material to each said tab.

14. The method of claim 12, wherein said side walls contain lateral perforations and said fitting step includes causing said bonding material to penetrate said perforations.

15. The method of claim 12, wherein the horseshoe includes a pad for preventing accumulation of material over an inner region of said top surface of the horseshoe.

16. The method of claim 12, wherein the horseshoe includes a longitudinal slot in each of said heel portions, said slot being adapted to receive a lateral extension of a wedge insert;

17. The method of claim 12, wherein the horseshoe includes a rigid plate incorporated into each side of said horseshoe, said plate including slots aligned with said notches in the bottom surface of the horseshoe.

18. A method of fitting a horse shoe to a hoof of a horse, comprising the following steps:
providing a horse shoe that includes:
a horseshoe with heel portions defining a gap, a top surface of the horseshoe including a grid of recesses for receiving an adhesive material and a bottom surface thereof including a plurality of notches suitable for driving a nail therethrough;
a rigid plate incorporated into each side of said horseshoe, said plate including slots aligned with said notches in the bottom surface of the horseshoe;
an upper with two side walls attached to a rear lateral periphery of the horseshoe and folded inward to butt against a hoof of a horse wearing the shoe;
a toe clip attached to a front end of the horseshoe; and
a bridge connecting the heel portions of the horseshoe;
wherein the bridge is a resilient structure cantilevered inward from said heel portions of the horseshoe so as to urge closure of said gap when the horseshoe is expanded during fitting of the shoe.
removing said side walls from the horseshoe;
fitting the shoe to the hoof of the horse by sliding the horseshoe to press against the toe clip, and by widening the gap of the horseshoe by an amount necessary to register the horseshoe with a bottom surface of the hoof;
driving nails into said notches of the shorseshoe and through the hoof; and
clinching the nails.

19. The method of claim 18, wherein the horseshoe includes a longitudinal slot in each of said heel portions, said slot being adapted to receive a lateral extension of a wedge insert.

20. The method of claim 18, wherein said widening step includes introducing said wedge insert into said longitudinal slots in the heel portions of the horseshoe so as to enlarge said gap by a desired predetermined amount.

21. The method of claim 20, further comprising the step of removing the insert from the horseshoe after the step of driving nails into the notches of the shorseshoe.

22. The method of claim 18, wherein the horseshoe includes a pad for preventing accumulation of material over an inner region of said top surface of the horseshoe.

23. The method of claim 18, wherein the horseshoe includes a rigid plate incorporated into each side of said horseshoe, said plate including slots aligned with said notches in the bottom surface of the horseshoe.

24. The method of claim 18, wherein the horseshoe includes a lateral tab attached to each side of a front lateral periphery of the horseshoe, said tab extending no more than ¾ of an inch above the top surface of the horseshoe.

25. A method of correcting a contracted-heel condition in a horse, comprising the following steps:
providing a horse shoe that includes:
a horseshoe with heel portions defining a gap, a top surface of the horseshoe including a grid of recesses for receiving an adhesive material and a bottom surface thereof including a plurality of notches suitable for driving a nail therethrough;
a longitudinal slot in each of said heel portions adapted to receive a lateral extension of a wedge insert;
a toe clip attached to a front end of the horseshoe; and
a bridge connecting the heel portions of the horseshoe;
wherein the bridge is a resilient structure cantilevered inward from said heel portions of the horseshoe so as to urge closure of said gap when the horseshoe is expanded during fitting of the shoe;
alternatively:
fitting the shoe to the hoof of the horse by sliding the horseshoe to press against the toe clip, and by introducing a wedge insert into said slots in the heel portions so as to enlarge said gap by a predetermined amount necessary to register the horseshoe with a bottom surface of the heel;
driving nails into said notches of the shorseshoe and through the hoof; and
clinching the nails;
or:
applying bonding material on said top surface of the horseshoe and on interior surfaces of the side walls prior to said fitting step;
fitting the shoe to the hoof of the horse by stretching the heel portions to widen the gap in the horseshoe, sliding the horseshoe to press against the toe clip, and releasing the heel portions to cause the side walls to clamp around the hoof; and
holding the shoe in place until the bonding material has cured;
and periodically replacing said wedge insert with a wider wedge insert to accommodate and promote a natural expansion of the hoof's footprint.

26. The method of claim 25, wherein said wedge insert and wider wedge insert are fastened to the heel portions of the horseshoe.

27. The method of claim 25, wherein the horseshoe includes a lateral tab attached to each side of a front lateral periphery of the horseshoe, said tab extending no more than ¾ of an inch above the top surface of the horseshoe.

28. The method of claim 25, wherein the horseshoe includes a pad for preventing accumulation of material over an inner region of said top surface of the horseshoe.

29. The method of claim 25, wherein the horseshoe includes a rigid plate incorporated into each side of said horseshoe, said plate including slots aligned with said notches in the bottom surface of the horseshoe.
